(19) United States
(12) Patent Application Publication
(10) Pub. No.: US 2025/0230935 A1
(43) Pub. Date: Jul. 17, 2025

(54) UNDERFLOOR HEATING SYSTEM, INCLUDING HEATING PANELS FOR SUCH A SYSTEM AND METHODS OF MANUFACTURE

(71) Applicant: Haydale Graphene Industries PLC, Ammanford, Carmarthenshire (GB)

(72) Inventors: John-Mark Seymour, Ammanford (GB); Thomas Harry Howe, Ammanford (GB); Elliot Owen Jones, Ammanford (GB)

(21) Appl. No.: 18/703,078

(22) PCT Filed: Oct. 20, 2022
(86) PCT No.: PCT/EP2022/079291

§ 371 Date: Apr. 19, 2024

(30) Foreign Application Priority Data
Oct. 20, 2021 (GB) 2115023.0

(51) Int. Cl. F24D 13/02; B32B 27/08; B32B 27/20; F24D 19/10; H05B 3/14

(52) U.S. Cl. CPC F24D 13/024; B32B 27/08; B32B 27/20; F24D 19/1096; H05B 3/146; B32B 2264/10; B32B 2264/301; B32B 2307/202; B32B 2307/206; B32B 2307/7376; B32B 2471/00; H05B 2203/026; H05B 2214/04

(57) ABSTRACT

The present invention relates to heating panels for underfloor heating, heated flooring elements, and a heating system comprising one or more heating panels. Methods for manufacturing said heating panels are also provided. The heating panels comprise a conductive layer of graphene particles dispersed in a polymer matrix material, wherein the graphene particles have an oxygen content of less than 4 at % and a nitrogen content of at least 3 at %. The heated flooring element comprises one or more heating panels in contact with, and optionally adhered to, at least a portion of a flooring layer.

### FIELD OF THE INVENTION

The present invention relates to heating panels for underfloor heating, heated flooring elements, and a heating system comprising one or more heating panels. Methods for manufacturing said heating panels are also provided.

### BACKGROUND

Cold housing and working conditions are linked to health issues such as raised blood pressure and increased risk of cardiovascular disease. Therefore, it is important to provide effective heaters for homes and buildings. Environmental reasons and energy costs also make it desirable to provide more efficient heaters with lower energy usage requirements and which can be powered by renewable energy sources.

It is known that underfloor heating provides more efficient and consistent heating than radiators which heat the air nearest them first and can leave ‘cold spots’ in the middle of a room whilst the areas close to the radiators are very hot. Underfloor heating provides radiant heating from the ground up, which provides more uniform heating and requires lower temperatures than radiators to warm a room effectively. It also allows more space and design freedom in rooms without radiators taking up space.

Underfloor heating is traditionally achieved in one of two ways: either ‘dry’ electric techniques where wiring is run underfloor, loose or attached to a mat, or ‘wet’ systems where pipes circulate warm water under the floor from a boiler or other water heating system. Both these traditional systems can be complex and disruptive to install and have significant associated upfront installation costs. They also suffer from lengthy heat-up times requiring users to turn on the heaters and start consuming energy well before the heating effects are felt. Traditional electric heating systems are costly to run and less powerful than water-based systems but do not require any regular servicing. Water systems on the other hand are bulky and can require raised floors to fit the pipes in as well as reviews to check for any issues. On top of this, ‘serpentine’ path wire or pipe set-ups can also have problems achieving complete and uniform coverage of a room without hotspots, particularly rooms that are unusual in shape.

Recently, it has been proposed to use graphene in underfloor heating applications. Graphene can produce far-infrared radiation via resistive heating. This process has improved heat dissipation efficiency compared to other electric heaters and heats up people and objects in a room rather than heating via convection. Far-infrared heating therefore helps subjects feel warmer while using less energy and can also help with allergies that are aggravated by dust circulation during convection heating. However, the technology is not yet mature, and there remains a need to provide improved systems.

### SUMMARY OF THE INVENTION

The present inventor has studied various characteristics of graphene particles with particular emphasis on their suitability for use in heating. Traditionally, graphene particles with oxygen functionalisation were considered preferable for providing resistive heating. The reason is that the oxygen functionalisation provided the graphene particles with good dispersibility in the polymer matrix material. However, the inventor has surprisingly found that alternative functionality of the graphene particles can lead to graphene particles not only having excellent dispersibility, but also improved conductivity and, accordingly, improved resistive heating. This finding has formed the basis of the present invention.

In a first aspect, the present invention provides a heating panel for underfloor heating comprising a conductive layer of functionalised graphene particles dispersed in a polymer matrix material, wherein the graphene particles have a nitrogen content of at least 3 at % and have an oxygen content of less than 4 at %.

Suitably, the heating panel comprises one or more protective layers encapsulating the conductive layer. Preferably the one or more protective layers comprise one or more electrically insulating layers encapsulating the conductive layer.

Optionally, the one or more protective layers comprise one or more water-resistant or waterproof layers encapsulating the conductive layer.

Optionally, the heating panel comprises a thermally insulating and/or reflective layer.

In a second aspect, the present invention provides a heating system for underfloor heating, comprising one or more heating panels of the first aspect.

Suitably, the heating system comprises a temperature control system to control the temperature of the panels.

In a third aspect, the present invention provides a heated flooring element comprising a flooring layer and a heating panel of the first aspect in contact with (optionally adhered to) at least a portion of the flooring layer, wherein the heating panel comprises a conductive layer of functionalised graphene particles dispersed in a polymer matrix material, wherein the graphene particles have a nitrogen content of at least 3 at % and have an oxygen content of less than 4 at %.

The flooring layer may be an upper floor layer or an underlay. The upper floor layer may be a natural flooring such as wood (including engineered wood), bamboo, rubber, resin, cork, or stone; or synthetic flooring such as laminate, vinyl, linoleum, or concrete; or tile flooring such as ceramic, or porcelain; or textile flooring such as carpet, or rugs. The underlay may be soft underlay such as polymer foam, rubber or cork; or rigid underlay such as wood or cement board.

In further aspects, the present invention provides methods of making the heating panel of the first aspect, methods of constructing the heating system of the second aspect, and the heated flooring element of the third aspect.

Further aspects relate to the use of graphene particles in an underfloor heating system, wherein the graphene particles have a nitrogen content of at least 3 at % and have an oxygen content of less than 4 at %, the use of a heating panel according to the first aspect of the invention in an underfloor heating system, and the use of heated flooring elements according to the third aspect of the invention in underfloor heating. All aspects of the invention may be for domestic use such as underflooring heating in homes or commercial use such as underfloor heating in office buildings, factories or manufacturing sites, or warehouses. Other uses include application of heating panels as wall or ceiling heaters.

The oxygen content and nitrogen content of the functionalised graphene particles of the present invention may be measured by X-Ray Photoelectron Spectroscopy (XPS).

In general, XPS measures surface composition. Accordingly, where oxygen (or nitrogen) content is referred to herein, it applies to measurements of the surface oxygen/nitrogen content (i.e. the value provided by XPS as carried out as described herein).

Herein, we use language such as “nitrogen functionalisation” to refer to nitrogen at the surface of the graphene particles.

The present invention has a number of advantageous features.

Firstly, the heating conductive layer of the heating panel is made from carbon (in the form of functionalised graphene particles) and polymer, which are relatively low cost compared to known heating elements based on, for example, metals such as silver. Therefore, the heating panel provides a cost effective and a simple way of heating a room or area.

Secondly, the functionalised graphene particles display high conductivity and high dispersibility in the polymer matrix material, meaning that they can form a suitably conductive layer in the heating panel at relatively low loading levels in the polymer matrix material. These low loading levels mean that the mechanical properties of the heating panel can be dominated by the relatively more flexible polymer matrix material, instead of the less flexible graphene particles. The small size of the graphene particles also lessens the impact of the particles on the mechanical properties of the heating panel compared to relatively larger particles.

Thirdly, the flexibility, thin profile, and low weight of the heating panel enabled by the use of functionalised graphene particles mean that transport of the heating panels is relatively easy, and installation of the heating panels as underfloor heating is relatively simple. For example, there is no need for raised floor levels as in water-based underfloor heating systems as the heating panels only add a thickness of a few millimetres. The flexibility allows the heating panels to be simply rolled out during installation and fit a more universal selection of rooms without particular moulding or other processes to account for uneven or unusually shaped surfaces. This also reduces installation costs. The heating panels are more robust and adaptable to deformation of the floor relative to a less flexible panel which would be more at risk of cracking.

Fourthly, the graphene-based heating panel can have a rapid temperature response to applied voltages and good heat stability. For example, the inventor has found that graphene-based heating panels as used in the present invention can settle at an equilibrium temperature after approximately 20 seconds and will cool down within seconds of the voltage being removed. This is most probably due to the graphene nanoparticles' excellent thermal conductivity properties. This improves heat efficiency as rooms can be heated only when required and hence lowers overall energy use for heating.

Fifthly, the uniformity of the heat distribution of a graphene-based heating panel compared to that of a traditional serpentine wire heater is improved, due to the ability to provide more even/uniform heat to an area. This again allows for a safer and more controlled application of heat since it reduces the likelihood of the formation of hot spots and provides fast, even heating across large areas without taking up much space.

Sixthly, the power requirements of the heating panel are relatively low, due to the excellent electrical and thermal properties of the graphene particles dispersed in the polymer matrix. This means that the heating panels can be retrofitted to buildings or integrated with current heating systems without necessarily requiring extra transformers or new power supplies. Consequently, the heating panels are easy to install for underfloor heating and more convenient than previous wired electrical or water pipe underfloor heating methods. The low power and low voltage requirements also mean that the heating panels can work with batteries or, for example, solar power as well as mains electricity. The ability to run underfloor heating from renewable energy sources makes it more environmentally sustainable and can potentially reduce running costs.

The present invention also provides some advantages compared to previously known graphene-based materials proposed for underfloor heating application. Without wishing to be bound by any theory, the inventor believes that the combination of high nitrogen content and low oxygen content provides both good dispersibility of graphene particles in the polymer matrix material and increased conductivity of the graphene particles within the heating panel. This is unexpected, for example, because oxygen functionality improves dispersibility of graphene particles in many polymer matrix materials. Therefore, it was expected that removal of oxygen content would lead to lower dispersibility in the polymer matrix material and consequently heating panels comprising such might have comparatively low conductivity (or require undesirably high graphene particle loadings). However, the inventor has discovered that the combination of low oxygen content with nitrogen functionalisation leads to heating panels with excellent dispersibility and—due to low oxygen content—higher conductivity. Importantly, the inventor finds that their method of nitrogen functionalisation (plasma-based process) does not significantly disrupt the sp² carbon content of the graphene particles. Without being bound by any theory, it is believed that this is different from graphene oxide, where planar sp² carbon can be lost in favour of sp³ carbon bonds due to the harsh treatment processes used to produce graphene oxide. Therefore, the improved conductivity seen by removal of oxygen is retained following nitrogen functionalisation.

The present materials are prepared using environmentally friendly technology and do not use harsh or toxic chemicals.

### Conductive Layer

The heating panel of the present invention comprises a conductive layer of functionalised graphene particles dispersed in a polymer matrix material. The functionalised graphene particles have low oxygen content (less than 4 at %) and are nitrogen functionalised so as to have a nitrogen content of at least 3 at %.

The heating panel produces heat through resistive heating upon application of an electrical current. The amount of heat generated is determined by the relationship: power=V²/R. Accordingly, by reducing resistance in the heating panel, the present invention increases the power generated for a particular current/applied voltage.

To achieve safe and useful temperatures from suitable power supplies, the conductive layer typically has a resistance of 100Ω or less, 75Ω or less, 50Ω or less, 40Ω or less, 30Ω or less, 20Ω or less, 15Ω or less, 12Ω or less, 10Ω or less, or 8Ω or less. The resistance may be measured with a two point probe, optionally corner to corner. Advantageously, smaller resistances require lower voltages to achieve a desired power level, and hence the heating panel can run off a variety of electricity supplies including but not limited to mains electricity, a low voltage battery supply, or solar. Using low voltages can improve safety and the option to run off battery or solar power makes the heating system more environmentally friendly and potentially reduces running costs. This is particularly important when considering heating homes and buildings as heating consumes a lot of energy and can become very expensive.

The sheet resistance normalised to 25 μm may be, for example, 100Ω/square or less, 75 Ω/square or less, 50Ω/square or less, 40Ω/square or less, 30Ω/square or less, 20 Ω/square or less, 15Ω/square or less, 12Ω/square or less, 10Ω/square or less, or 8 Ω/square or less. The sheet resistance may be measured with a four point probe.

The heating panel of or used in the present invention may comprise a single layer of conductive material, or be formed from multiple stacked layers (e.g. 2, 3, 4 or 5) of conductive material. Coating/printing multiple stacked layers to form the heating panel can result in a more uniform thickness (and hence more uniform heating) than coating/printing a single layer of the same overall thickness.

The average (mean) thickness of the conductive layer of the heating panel (i.e. mean distance between the bottom surface of the conductive layer and the top surface of the conductive layer) may be, for example, less than 300 μm, less than 200 μm, less than 150 μm, less than 100 μm, less than 75 μm, less than 50 μm, or preferably less than 30 μm or less than 20 μm. The lower limit for the average thickness of the conductive layer may be, for example 1 μm, 3 μm, 5 μm or 10 μm. Preferably, the average thickness is 1 to 100 μm, 1 to 75 μm, or more preferably 10 to 20 μm, and most preferably 13 to 16 μm. In instances where the conductive layer of the heating panel is formed from multiple layers, each layer may have a maximum average thickness of, for example, 50 μm, 25 μm, 15 μm, 10 μm or 5 μm. The minimum average thickness may be, for example, 0.5 μm, 1 μm, 3 μm or 5 μm. Preferably, the average thickness of each layer is 1 to 15 μm. Advantageously, such thicknesses allow the heating panel to be easily deformable/reformable and provide sufficient resistance for the required heating whilst allowing a relatively thin device to be produced.

### Graphene Particles

The conductive layer of the heating panel in the present invention comprises or consists essentially of functionalised graphene particles (referred to as “graphene particles” herein for brevity) dispersed in a polymer matrix material. The graphene particles are conductive and allow heating of the heating panel through resistive (Joule) heating.

The graphene particles may be randomly dispersed in the polymer matrix material. Providing carbon in this form instead of, for example, in the form of woven carbon microfibre sheets encased within a polymer matrix material, simplifies manufacture and reduces expense. Furthermore, the conductivity of graphene particles (which is higher than, for example carbon black and graphite) means that a conductive layer can be formed with relatively low loadings. In addition, using carbon particles in this form allows the conductive layer to be applied using coating (e.g. printing) techniques, which simplifies manufacture compared to use of woven carbon microfibre, particularly when used to form complex shapes. Using coating techniques also enables simple manufacture of heating panels covering relatively large areas.

Suitably, the graphene particles have a high aspect ratio. Advantageously, graphene particles having a high aspect ratio can form conductive paths at relatively low loading levels, helping to improve the flexibility of the heating panel.

The graphene particles (which can be referred to as “graphene-material particles”, or “graphene-based particles”) may take the form of monolayer graphene (i.e. a single layer of carbon) or multilayer graphene (i.e. particles consisting of multiple stacked graphene layers). Multilayer graphene particles may have, for example, an average (mean) of 2 to 100 graphene layers per particle. When the graphene particles have 2 to 5 graphene layers per particle, they can be referred to as “few-layer graphene”.

Advantageously, these forms of carbon nanoparticles provide extremely high aspect ratio conductive particles. This high aspect ratio allows the formation of conductive paths at relatively low loading levels, decreasing the volume of the heating panel occupied by the carbon nanoparticles and thus increasing the flexibility/stretchability of the heating panel.

The graphene particles may take the form of plates/flakes/sheets/ribbons of multilayer graphene material, referred to herein as “graphene nanoplatelets” (the “nano” prefix indicating thinness, instead of the lateral dimensions).

The graphene nanoplatelets may have a platelet thickness less than 100 nm and a major dimension (length or width) perpendicular to the thickness. The platelet thickness is preferably less than 70 nm, preferably less than 50 nm, preferably less than 30 nm, preferably less than 20 nm, preferably less than 10 nm, preferably less than 5 nm. The major dimension is preferably at least 10 times, more preferably at least 100 times, more preferably at least 1,000 times, more preferably at least 10,000 times the thickness. The length may be at least 1 times, at least 2 times, at least 3 times, at least 5 times or at least 10 times the width.

The loading of graphene particles in the polymer matrix material may be, for example, 0.25 wt. % or more, 0.5 wt. % or more, 1 wt. % or more, 2 wt. % or more, 5 wt. % or more, 10 wt. % or more, 15 wt. % or more, 20 wt. % or more, 30 wt. % or more, 40 wt. % or more, 50 wt. % or more or 60 wt. % or more of the total weight of the conductive layer of the heating panel. The upper limit for the loading of graphene particles in the polymer matrix material may be, for example, 5 wt. %, 10 wt. %, 15 wt. %, or preferably 20 wt. %, 25 wt. % or 30 wt. %. If the loading of graphene particles is too low then the resistance of the heating panel will be high, necessitating greater voltages to achieve a desired temperature. If the loading is too high, then this can adversely affect the mechanical properties of the heating panel (in particular, flexibility and stretchability). For these reasons, it is preferable for the loadings of the graphene particles to be in the range of, for example, 0.25 to 30 wt. %, 1 to 25 wt. %, or more preferably 5 to 20 wt. %. Optionally, the conductive layer may comprise additional carbon fillers such as graphite, carbon black, furnace black, carbon nanotubes, etc. Preferably the optional additional carbon filler is graphite and/or carbon black. Preferably the additional carbon filler loadings are 5 to 10 wt. % of the total weight of the conductive layer of the heating panel. The upper limit for the total carbon content of the conductive layer including the graphene and carbon filler may be 50 wt. % or less, 40 wt. % or less, or preferably 30 wt. % or less.

When the graphene particles are functionalised per the invention, uniform dispersion throughout the polymer matrix material can be achieved. This is important, since aggregates (clumps) of material may decrease the uniformity of heating of the heating panel in use and such particles have a powerful tendency to agglomerate and are difficult to disperse in solvents and polymer materials.

In the present invention, the graphene particles are functionalised graphene particles, e.g. functionalised graphene or functionalised graphene nanoplatelets. That is, the graphene particles incorporate functional groups which improve the affinity of the nanoparticles for the solvents and/or polymer matrix material used to form the heating element, thus allowing a more uniform distribution of particles to be achieved. Specifically, the graphene particles have a low oxygen content (less than 4 at %) and are nitrogen functionalised. The nitrogen functionality can be any suitable form such as amine, pyrrolic, pyridinic etc.

If desired, other functionality could be incorporated. For example, the graphene particles may also be halogen functionalised. Other functionalities incorporating oxygen (such as hydroxy functionalisation) are considered unsuitable for the present invention.

Preferably, the functionalised graphene particles are plasma-functionalised graphene particles (i.e. particles which have been functionalised using a plasma-based process). Advantageously, plasma-functionalised graphene particles can display high levels of functionalisation, and uniform functionalisation.

In particular, the inventor has found that when graphene particles are prepared using agitation in low-pressure plasma, such as described in WO2010/142953 and WO2012/076853 and especially preferably WO2022/058542, WO2022/058546 or WO2022/058218, they are readily obtained in a format enabling dispersion in solvents and subsequently in polymer matrices, or directly in polymer melts, at good uniformity and at levels more than adequate for the purposes set out above. This is in contrast to conventional processes for separating and functionalising graphene particles, which are extreme and difficult to control, as well as damaging to the particles themselves.

Specifically, the starting carbon material—especially graphitic carbon bodies—is subjected to a particle treatment method for disaggregating, de-agglomerating, exfoliating, cleaning or functionalising particles, in which the particles for treatment are subject to plasma treatment and agitation in a treatment chamber. Preferably the treatment chamber is a rotating container or drum. Preferably the treatment chamber contains or comprises multiple electrically-conductive solid contact bodies or contact formations, the particles being agitated with said contact bodies or contact formations and in contact with plasma in the treatment chamber.

Preferably the contact bodies are moveable in the treatment chamber. The treatment chamber may be a drum, preferably a rotatable drum, in which a plurality of the contact bodies is tumbled or agitated with the particles to be treated. The wall of the treatment vessel can be conductive and form a counter-electrode to an electrode that extends into an interior space of the treatment chamber.

During the treatment, desirably glow plasma forms on the surfaces of the contact bodies or contact formations.

Suitable contact bodies are metal balls or metal-coated balls. The contact bodies or contact formations may be shaped to have a diameter, and the diameter is desirably at least 1 mm and not more than 60 mm.

The pressure in the treatment vessel is usually less than 500 Pa. Desirably during the treatment, gas is fed to the treatment chamber and gas is removed from the treatment chamber through a filter. That is to say, it is fed through to maintain chemical composition if necessary and/or to avoid build-up of contamination.

The treated material, that is, the particles or disaggregated, deagglomerated or exfoliated components thereof resulting from the treatment, may be chemically functionalised by components of the plasma-forming gas, forming e.g. amine functionalities on their surfaces.

Plasma-forming gas in the treatment chamber may be or comprise e.g. nitrogen, ammonia, amino-bearing organic compound, halogen such as fluorine, halohydrocarbon such as CF₄, and noble gas. Most preferred is ammonia. Oxygen-functionalised materials, plasma-processed in oxygen, or oxygen-containing gas, are advantageously avoided for preparing materials according to the present invention.

Any other treatment conditions disclosed in the above-mentioned WO2010/142953 and WO2012/076853 and especially preferably WO2022/058542, WO2022/058546 or WO2022/058218 may be used, additionally or alternatively. Or, other means of functionalising and/or disaggregating carbon particles may be used for the present processes and materials, although we strongly prefer plasma-treated materials.

For the present purposes the degree of chemical functionalisation of the graphene particles is selected for effective compatibility at the intended loadings with the selected polymer matrix material. A typical upper limit is 21 at % nitrogen, because higher levels indicate the presence of impurities or loss of sp² carbon content (and therefore sub-optimal conductivity). A suitable lower limit is at least 3 at % of nitrogen, at least 5 at % of nitrogen, at least 10 at % of nitrogen, or at least 15 at % of nitrogen. Accordingly, appropriate ranges of nitrogen-functionalisation include nitrogen at 3-20 at %, such as 5-20 at % or 10-20 at %, preferably 5-19 at %, more preferably 10-18 at %. Other end-points can be combined appropriately.

As mentioned elsewhere, XPS is used to determine the extent (degree) of N functionalisation i.e. nitrogen content.

XPS uses monochromatic x-rays to eject core electrons from surface atoms in a sample. These core electrons have specific and well-documented binding energies, which are affected by an atom's chemical environment. As the electrons are ejected from the sample, they are counted, and the kinetic energy measured. This results in peaks in the output spectrum. As each electron is from a single atom, XPS is quantitative. The peak areas can be fitted to give distributions of area within the peaks at different binding energies. Thus, XPS is qualitative as well as quantitative, giving highly detailed and accurate chemical information of a material's surface.

Any suitable XPS spectrometer can be used to determine nitrogen and oxygen content. Such methods are well within the purview of the skilled person. The inventor uses a ThermoFisher K-α X-ray photoelectron Spectrometer System using an aluminium X-ray source. The sample area is usually in the shape of an ellipse having a maximum width of 400 μm and a measuring depth of up to 9 nm.

Other methods of characterising the oxygen and nitrogen contents of the graphene particles may be used. WO2015/150830 describes a method of characterising surface chemistry by monitoring changes in dispersion. Other measurements that can be made include zeta potentials, which correlate with the degree of nitrogen functionalisation but do not show precisely the amount of nitrogen present in the sample. The inventor finds that nitrogen-functionalised graphene particles having less than 4 at % of oxygen and at least 3 at % of nitrogen show a zeta potential at pH 3 of more than 3 mV, such as at least 10 mV, at least 25 mV, at least 35 mV, preferably more than 40 mV. See also FIG. 3.

The skilled person will be aware of suitable methods for measuring zeta potentials. An exemplary method involves dispersing 10 mg of functionalised graphene particles in 20 mL of pH 3 solution, adding aliquots of the dispersion in a cell which is then placed in a Malvern Zetasizer Nano-Z instrument. During the measurement, a potential difference is applied at either end of the cell and the voltage is measured and recorded. The results may then be cross-referenced against a standard.

Similar to the zeta potential, measurement of the acid number can be used to confirm nitrogen functionalisation of the particles. The skilled person will be aware of suitable methods for measuring the acid number. An exemplary method involves measurement with a Mettler Toledo InMotion Pro titrator and autosampler, where the sample is neutralised with potassium hydroxide and titrated against e.g. HCl (hydrogen chloride) giving the equivalence points of any acids present. In particular, the acid number for unfunctionalised graphene particles is typically a positive value, while nitrogen functionalisation leads to a negative acid number such as −0.10 or −0.15 mg·KOH/g. See also FIG. 4.

The graphene particles of the present invention have an oxygen content of less than 4 at %. Lower oxygen contents are believed to be even more advantageous from the perspective of improved conductivity, so preferred are graphene particles having an oxygen content of less than 2 at %, preferably less than 1.5 at %, more preferably less than 1 at % such as less than 0.5 at %.

Although it is possible to buy graphene particles having low oxygen content, commercially available graphene particles typically contain around 5 at % of oxygen even in the absence of treatments to specifically introduce oxygen. Such oxygen contents are too high for the present invention. Furthermore, it may be desirable to reduce the oxygen content of the graphene particles starting material, to further enhance the benefits of the present invention. This can be achieved by any suitable process. In such process, it is necessary to remove moisture because the graphene particles can become oxygen functionalised in the presence of moisture.

An exemplary process that can be used to reduce oxygen content is annealing. Such may take place in argon, to avoid the presence of moisture or oxygen from the air.

As the skilled person will be aware, annealing is a process of heating to a predetermined temperature for a predetermined length of time, followed by slow cooling. In the present case, annealing may be used to achieve reduced oxygen content of the graphene particles.

The skilled person can determine suitable conditions, but heating to a temperature of e.g. 600-1000° C. such as 850° C. for 1-5 hours followed by cooling for 1-5 hours might be suitable. Such conditions have been found to have only a small effect on the sp² carbon content as determined by XPS.

Preferably, the sp² carbon content of the functionalised graphene particles is at least 65 at %, such as at least 70 at % or more.

The inventor believes that annealing before nitrogen treatment may remove oxygen and restore sp² carbon, while heating during and after the treatment removes volatiles including any potential NOₓ.

It is generally preferable to nitrogen-functionalise graphene particles which already have the required low oxygen content, to maximise the available carbon for functionalising. The annealing can be carried out before, partway through (such as midway through), or after the plasma functionalisation and can involve the use of a furnace or the use of a heated reactor barrel as in patent application number WO2022/058542.

For example, annealing can be carried out first to ‘clean’ a sample by removing oxygen, moisture and other impurities. This is carried out under argon (or other inert gas, such as nitrogen, particularly if in an oven or furnace). That process is followed by nitrogen functionalisation, followed by annealing again, if wanted.

Other forms of conductive particle filler may be used in the heating panel alongside the graphene particles. For example, the heating panel may further comprise carbon nanotubes (single-walled or multi-walled), carbon black, or metal particles (e.g. silver particles).

### Polymer Matrix Material

Suitably, the polymer matrix material of the heating panel is an elastic material. The particular choice of elastic material is not particularly limited, provided that it is sufficiently elastically deformable at normal operating and installation conditions of the heating panel and holds the graphene particles in position (so that the distribution of graphene particles does not change over time).

Suitable materials include, for example, vinyl polymers (including polymers or copolymers of vinyl chloride, vinyl acetate and vinyl alcohol), polyester polymers, phenoxy polymers, epoxy polymers, acrylic polymers, polyamide polymers, polypropylenes, polyethylenes, silicones, elastomers such as natural and synthetic rubbers including styrene-butadiene copolymer, polychloroprene (neoprene), nitrile rubber, butyl rubber, polysulfide rubber, cis-1,4-polyisoprene, ethylene-propylene terpolymers (EPDM rubber), and polyurethane (polyurethane rubber). The polymer matrix material may be, for example, a copolymer of vinyl chloride, vinyl acetate and/or vinyl alcohol.

The polymer matrix material may be a thermoplastic material. Alternatively, the polymer matrix material may be a thermosetting material.

The polymer matrix material may comprise or be polyurethane, for example a thermoplastic polyurethane elastomer. Advantageously, the present inventor has found that using polyurethane (especially thermoplastic polyurethane elastomer) as the polymer matrix material produces heating panels with good mechanical properties, in particular a good level of flexibility. This helps the heating panels conform to the shape of the floor they are laid under and makes them relatively easy to install and transport.

### Heating Panel

The heating panel of or used in the present invention may comprise a single layer or multiple stacked layers of conductive material printed onto a substrate, with an encapsulating laminate. The substrate is preferably a thermoplastic sheet. The encapsulating laminate may be, for example, a resin varnish and/or other thermoplastic laminate.

The heating panel may comprise one or more protective layers encapsulating the conductive layer. Preferably, the protective layers are electrically insulating. The protective layers may be water-resistant or waterproof and form a watertight seal around the conductive layer of the heating panel. Most preferably, the conductive layer is printed onto a base protective layer and a covering protective layer is coated (e.g. printed) on top to encapsulate the conductive layer. Advantageously, the protective layers help to improve the mechanical properties of the heating panel. In particular, it reduces the occurrence of cracking of the conductive material upon deformation of the panel. Furthermore, the electrically insulating layers prevent short-circuits forming if different regions of the heating panel are brought into contact (which might otherwise lead to non-uniform heating). In addition, the protective layers can protect the heating panel from other damage such as water damage, to ensure the heating panels are safe and resilient. This is particularly important for use in underfloor heating where the panels may commonly become exposed to leaks, spillages, and other moisture.

Preferably, the protective layers are formed from an elastic material, e.g. an elastic polymer. This allows the protective layers to mechanically adapt as the panel is flexed or rolled.

Suitable materials include, for example, vinyl polymers (including polymers or copolymers of vinyl chloride, vinyl acetate and vinyl alcohol), polyester polymers, phenoxy polymers, epoxy polymers, acrylic polymers, polyamide polymers, polypropylenes, polyethylenes, silicones, elastomers such as natural and synthetic rubbers including styrene-butadiene copolymer, polychloroprene (neoprene), nitrile rubber, butyl rubber, polysulfide rubber, cis-1,4-polyisoprene, ethylene-propylene terpolymers (EPDM rubber), and polyurethane (polyurethane rubber). The material of the covering layers may be, for example, a copolymer of vinyl chloride, vinyl acetate and/or vinyl alcohol. In preferred embodiments, the protective layer comprises or is the same material as the polymer matrix material.

Preferably, the protective layers are formed from a coatable material, such as a polymer ink. For example, the layer may be formed by polymer ink comprising a suspension of polymer particles in a liquid plasticizer (for example “Plastisol®”—a suspension of PVC particles in a liquid plasticizer), which can be printed and cured, for example, by heating.

The protective layers may comprise or be formed from polyurethane, for example a thermoplastic polyurethane elastomer. Advantageously, the present inventor has found that using polyurethane (especially thermoplastic polyurethane elastomer) as the protective layers produces heating panels with good mechanical properties, in particular a good level of flexibility. This helps the heating panel conform to the area it is being laid on and simplifies installation and transport.

The protective layers may be, or comprise, silicone rubber, since this can provide excellent flexibility and deformability without cracking.

The heating panel may comprise a thermally insulating and/or reflective layer or layers. For example, the heating panel may have a metal foil (e.g. aluminium foil) layer to reflect heat upwards to the room. This is important for use in underfloor heating to ensure the heat produced is directed to the space in which it is required and not wasted heating the material below the panel.

The average (mean) thickness of the heating panel (i.e. mean distance between the bottom surface of the heating panel and the top surface of the heating panel) may be, for example, less than 10 mm, less than 8 mm, less than 5 mm, less than 4 mm, or preferably less than 3 mm. The lower limit for the average thickness of the heating panel may be, for example 0.1 mm, 0.3 mm, 0.5 mm, or 1 mm. Preferably, the average thickness is 1 mm to 4 mm, more preferably 1 to 3 mm. Where the heating panel is formed from multiple protective layers, each protective layer may have a maximum average thickness of, for example, 4 mm, 3 mm, 2 mm, 1 mm, 500 μm, 200 μm, 50 μm, 25 μm, 15 μm, 10 μm or 5 μm. The minimum average thickness may be, for example, 0.5 μm, 1 μm, 3 μm, 5 μm, 50 μm, 200 μm, 500 μm, or 1 mm. Preferably, the average thickness of each layer is 1 to 50 μm, or 0.5 to 3 mm. Advantageously, such thicknesses allow the heating panel to be easily deformable/reformable and provide sufficient protection to the conductive layer whilst forming a relatively thin device. This makes them relatively robust, easily transportable, and simple to install.

The heating panel may include electrical connectors on (e.g. abutting/overlaying) the conductive layer to facilitate connection of an external power supply and/or other panels. For example, the heating panel may include one or more metal (e.g. silver or copper) regions to facilitate the supply of electricity to the heating panel. Advantageously, these electrical connectors can simplify supply of power to the heating panel and can reduce the resistance of the heating panel.

The one or more electrical connectors may take the form of points, or lines/tracks, optionally formed into a pattern. For example, the electrical connectors may take the form of space lines or busbars.

The one or more electrical connectors may be located at the corners of the panels. Preferably, the electrical connectors are printed onto the heating panel.

### Heating System

The heating system for underfloor heating according to the third aspect of the invention may comprise more than one of the heating panels described above, such as 2, 3, 4, 5, 6, 7, 8, 9 or 10 heating panels. For example, the heating system may have multiple heating panels covering different areas of a room or building.

In embodiments in which the heating system comprises multiple heating panels, the heating panels may be electrically connected with the electrical connectors. For example, neighbouring heating panels may be connected by direct contact between one or more of the electrical connectors of the heating panel and one or more of the electrical connectors of the neighbouring heating panel or they may by connected indirectly with, for example, wires linking the electrical connectors. Preferably, the heating panels are both electrically and mechanically connected by overlaying the electrical connectors and forming a strong mechanical attachment between the heating panels. This electrical and mechanical connection may be achieved by a suitable connector, such as a rivet, staple or split pin, passed through the layers. Methods such as riveting, stapling, joining with a split pin, welding or otherwise adhering the heating panels together, preferably at the point of the electrical connectors may be used. The connection point may then be sealed with a protective layer, for example, a layer of the same material of the protective layers coating the conductive layer of the heating panel.

The heating system may comprise a temperature control system, to control the temperature of the heating panel(s). For example, the control system may allow the amount of power supplied to the heating panel to be adjusted, e.g. in a stepped or continuous manner. This may control switching on and off of the heating panel and/or switching between lower and high-power settings.

In embodiments in which the heating system comprises multiple heating panels, the control system may allow independent control over the temperature of each, or a subset of, the heating panels. For example, in a heating system comprising multiple heating panels which cover different sections of a room, the control system may allow the temperature of heating panels to be independently adjusted according to the area.

The control system may include an interface (such as a button, switch, or dial) for a user to adjust the temperature of the heating panel(s). In addition, or alternatively, the control system may be programmable to adjust the power level according to a pre-determined program. In this way, heating provided by the heating system can be customised to a particular individuals preference, or a particular application.

Preferably, the control system is configured so that the temperature of the heating panel cannot exceed a certain threshold (as per the temperature ranges mentioned below). Furthermore, the control system may include a cut-off feature, which reduces or stops power supply when a certain temperature is reached.

The control system may be configured to control the temperature of the heating panel by voltage regulation, a positive temperature coefficient (PTC) thermistor, or by varying the duty cycle of the power supply.

Preferably, the heating system is heatable to achieve optimal room temperature upon application of power from the power supply. For underfloor heating, this means that the heating panel is heatable to temperatures in the range of 15° C. to 35° C. The ideal temperature depends on the flooring type above the heating panels and the preference of the user. For the avoidance of doubt, the temperatures above refer to the temperature of the heating panels themselves (as opposed to the temperature at a distance from the heating panels) as measured, for example, via a thermal imaging camera.

The maximum temperature achievable by the heating system upon supply of power from the power supply may be 70° C. or less, 60° C. or less, 55° C. or less, 50° C. or less, 45° C. or less, or 40° C. or less. These values are based on normal operation of the device (as opposed to temperatures achieved in the event that the device malfunctions). The maximum temperature of the heating system may be restricted by resistance balancing and thermocouples that cut off or reduce the power to the heating panel(s) if the temperature exceeds the set specification. Advantageously, designing the heating system to have a maximum temperature in the ranges above limits or prevents the possibility of the heating system damaging the materials and floor around it and/or other objects and people in the area being heated.

The heating system may further comprise software and/or hardware configured to run by an external application (“app”).

“Software” means a set of instructions that when installed on a computer configures that computer with the readiness to perform one or more functions. The terms “computer program,” “application” and “app” are synonymous with the term software herein.

In some embodiments, one or more of the electronic features, settings or characteristics of the heating system, such as temperature or battery level, can be viewed, selected, and/or adjusted remotely by a mobile electronic device, such as by way of a wireless communication protocol and/or using a software module or app on a mobile electronic device.

In particular, the software or app may allow a user to monitor the temperature of the heating panel(s) and to adjust the temperature appropriately. The app may also allow the user to adjust the period over which the heating panel(s) are heated (i.e. the app may act as a timer automatically switching off the heating after a set period of time).

In certain embodiments the heating system comprises a controller chip and a temperature sensor configured to measure the temperature of the heating panel(s) and to adjust their temperature. The controller chip may be configured to receive commands from a mobile device. These commands may be transmitted using WiFi or Bluetooth communication.

In particularly advantageous embodiments, the heating system is configured to align with a particular schedule e.g. a subject's daily routine. In some embodiments, the heating system is configured to allow a subject to input details of a schedule into the app. In some embodiments, the heating system is trainable to synchronise with (e.g. precede by a pre-set number of minutes) a schedule. In these embodiments, the heating system may be configured to turn on, achieve a desired temperature, and turn off after a defined period, according to the details of the input schedule.

The heating system of the present invention is connectable to an electrical power supply. The heating system may include the electrical power supply, or it may be supplied without an electrical power supply installed.

The electrical power supply may be mains electricity, a battery, a supercapacitor, solar power, or any other alternative.

In embodiments of the heating system comprising an included power supply, the protective layers of the heating panel may cover the power supply. In such situations, the protective layers may form a waterproof seal around the conductive layer and power supply. In such embodiments, the power supply may be rechargeable via electrical induction.

### Heated Flooring Element

The heated flooring element according to the third aspect of the invention comprises a flooring layer and a heating panel of the first aspect in contact with, or optionally adhered to, at least a portion of the flooring layer, wherein the heating panel comprises a conductive layer of functionalised graphene particles dispersed in a polymer matrix material, wherein the graphene particles have a nitrogen content of at least 3 at % and have an oxygen content of less than 4 at %.

The flooring layer may be an upper floor layer or an underlay. The upper floor layer may be a natural flooring such as wood (including engineered wood), bamboo, rubber, resin, cork, or stone; or synthetic flooring such as laminate, vinyl, linoleum, or concrete; or tile flooring such as ceramic, or porcelain; or textile flooring such as carpet, or rugs. The underlay may be soft underlay such as polymer foam, rubber or cork; or rigid underlay such as wood or cement board. The flooring layer may comprise a single layer or multiple layers adhered together.

The heating panel may be in contact with the flooring layer or it may be bonded (directly or indirectly) to the flooring layer. The heating panel may form a layer within the structure of the flooring layer. There may be an intermediate layer between the flooring layer and the heating panel. Advantageously, the intermediate layer may provide a uniform surface for adherence of the heating panel to the flooring layer and additional damage protection for the heating panel.

The flooring layer and heating panel may be manufactured separately and placed in contact with each other to form the heated flooring element, or the heated flooring element may be produced by depositing (e.g. printing) the heating panel directly onto the flooring layer. In the case where the flooring layer comprises an electrically insulating material the flooring layer may function as a protective layer of the heating panel, allowing the conductive layer of the heating panel to be deposited directly onto the flooring layer.

The heated flooring element or multiple heated flooring elements may form part of a heating system according to the second aspect of the invention as described above.

### Applications

The heating panel, heating system and heated flooring element may be used for heating in a range of settings, both domestic and commercial. These settings include residential settings such as houses, flats, or apartments in rooms including, but not limited to, bedrooms, kitchens, bathrooms, hallways, living areas, dining areas, workspaces, or garages; vehicles, such as caravans, boats, cars, trains, or planes; commercial settings such as offices, shops, restaurants, studios, portable working areas, or any other buildings, including temporary or portable buildings; industrial settings such as factories, warehouses, or storage facilities, for example, specific food and goods storage areas; external settings such as driveways, footpaths, outdoor seating areas, outdoor events areas, or other areas where de-icing may be desirable. The heating panel, heating system and heated flooring element are preferably for use in residential or domestic settings.

A further aspect of the present invention is use of a heating panel, heating system, or heated flooring element in heating at least part of a residential building.

Another further aspect of the present invention is use of a heating panel, heating system, or heated flooring element in heating caravans, or boats.

### Manufacturing Methods

In a further aspect, the invention provides a method of making a heating panel according to the first aspect, comprising:
providing an electrically insulating substrate material; and
depositing one or more layers of a conductive material onto at least a portion of the substrate material; and
depositing an electrically insulating covering layer onto said one or more layers of conductive material;
   wherein the conductive material comprises graphene particles dispersed in a polymer matrix material, and wherein the graphene particles have an oxygen content of less than 4 at % and a nitrogen content of at least 3 at %.

Preferably, the method of making a heating panel includes preparation of the conductive material using a method comprising:
providing a starting carbon material, comprising graphitic particles;
optionally annealing the starting material to remove oxygen;
subjecting the annealed material to plasma treatment and agitation in a treatment chamber;
chemically functionalising the carbon material by components of the plasma-forming gas, which is preferably ammonia; and
dispersing the functionalised material in a polymer matrix material.

Optionally, the method above may involve additional steps to deposit further protective layers and, for example, thermally insulating layers may be included before and/or after depositing the conductive material.

The step of depositing one or more layers of a conductive material over the substrate material preferably involves depositing (coating) a conductive ink on the substrate material.

Suitable deposition techniques include, for example, bar coating, screen printing (including rotary screen printing), flexography, rotogravure, inkjet, pad printing, and offset lithography.

The conductive ink comprises the functionalised graphene particles dispersed in a solvent and polymer material.

When multiple layers of conductive ink are printed, each layer is preferably dried before a subsequent layer is added. The device may be heated after the application of each conductive ink layer to speed up drying of the ink.

When using a conductive ink, the method preferably involves a step of preparing the ink for printing. This preparation step may involve mixing or homogenising the ink to evenly distribute the graphene particles in the ink's polymer binder. Preferably, the preparation step involves homogenising the ink, since the inventor has found that this ensures a uniform distribution of carbon nanoparticles and can help to break up agglomerates of nanoparticles in the ink. Suitable homogenisation can be achieved using, for example, a three roll-mill or rotor-stator homogeniser.

A further aspect of the invention is a method of constructing a heating system according to the second aspect, comprising;
providing one or more heating panels;
electrically connecting each, or a subset of, the heating panels, preferably by overlaying and riveting together the electrical connectors;
connecting the heating panels to a temperature control system; and
connecting the heating panels to a suitable power supply.

The connection between heating panels may have any of the optional or preferred features described previously such as wired connections or mechanical connections and may involve an additional step of depositing another protective layer to seal the connection.

In a further aspect, the invention provides a method of manufacturing a heated flooring element according to the third aspect, comprising;
providing a portion of flooring layer; and
depositing one or more layers of a conductive material onto at least a portion of the flooring layer; and
depositing an electrically insulating covering layer onto said one or more layers of conductive material;
   wherein the conductive material comprises graphene particles dispersed in a polymer matrix material, and wherein the graphene particles have an oxygen content of less than 4 at % and a nitrogen content of at least 3 at %.

Alternatively, the flooring layer and heating panel (according to the relevant method above) may be manufactured separately and then placed in contact with each other to form the heated flooring element.

### BRIEF DESCRIPTION OF THE FIGURES

Embodiments of the invention will now be described, by way of example only, with reference to the accompanying drawings in which:

FIG. 1 is an XPS spectrum of a comparative sample of graphene particles having low oxygen content and no nitrogen-functionalisation treatment.

FIG. 2 is an XPS spectrum of a sample of graphene particles according to the invention, having low oxygen content and nitrogen functionalisation.

FIG. 3 is a graph showing zeta potentials of batches of graphene particles having (left) no nitrogen functionalisation and (three rightmost) nitrogen functionalisation.

FIG. 4 is a graph showing acid numbers of batches of graphene particles having (left) no nitrogen functionalisation and (three rightmost) nitrogen functionalisation.

FIG. 5 are graphs showing (upper) the change in O content of graphene particles before and after annealing (compare left with middle) and a commercially-available low-oxygen graphene particles (right), and (lower) the change in sp² carbon content for those same graphene particles as in the upper graph.

FIG. 6 is a photograph showing (left) polymer matrix material with graphene particles not functionalised according to the present invention, and (right) functionalised graphene particles in line with the present invention.

FIG. 7 is a graph showing the temperature response with time of an enclosed room, heated by four heating panels.

### DETAILED DESCRIPTION

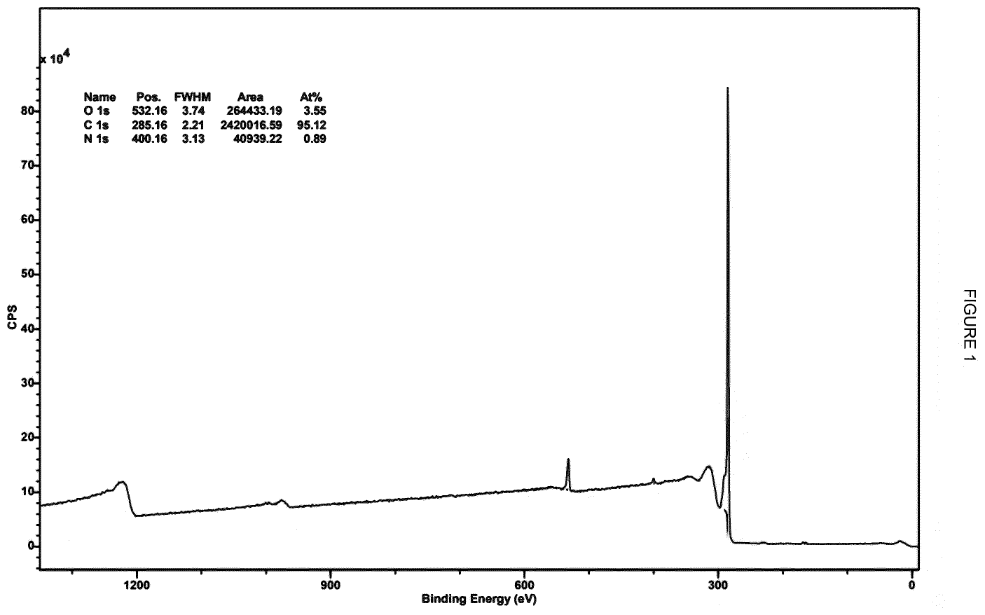

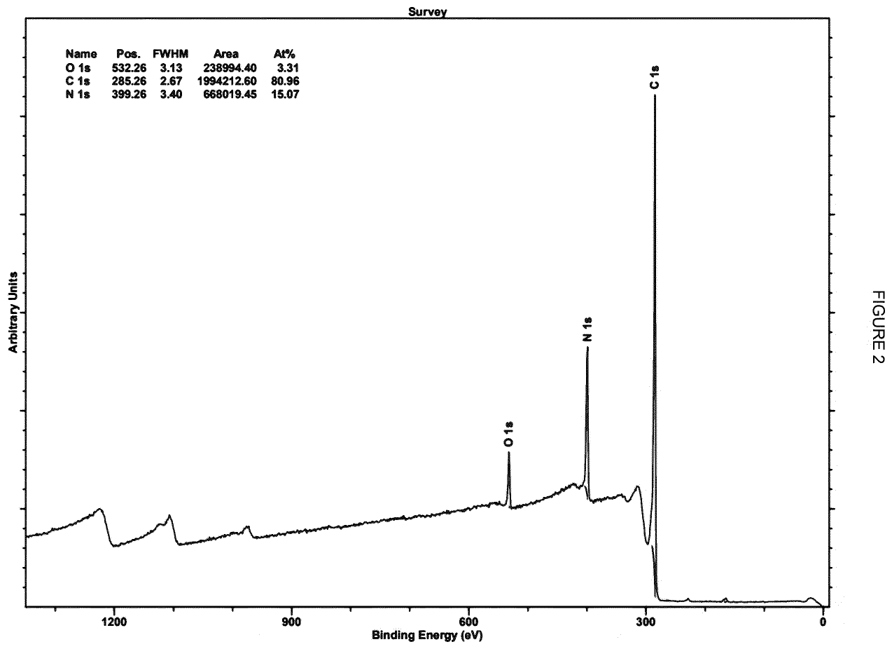

FIGS. 1 and 2 are XPS spectra showing the change that can be observed when nitrogen functionalisation is carried out on a sample of low-oxygen grade graphene particles. In this case, ammonia plasma treatment was carried out and subsequently XPS was used to identify the change in nitrogen (N) at %. It can be seen that the ammonia plasma treatment generates more than 14% increase in chemically bonded surface nitrogen atoms.

The N(1s) XPS peaks can be deconvoluted to give fine detail on nitrogen functionality such as pyrrolic, pyridinic, graphitic, amine, imine or nitric functionalities. Further XPS studies showed (fitting referenced with J. Vac. Sci. Technol. A 38(3) May/June 2020; doi: 10.1116/1.5135923) that the N(1s) peak of FIG. 2 could be attributed primarily to pyridinic N (53.35%) and amine or Ngr (34.01%) nitrogen. [Ngr is graphitic nitrogen, a nitrogen substituting a carbon in the graphene layer as shown in the fitting reference]. By comparison, the spectrum from the sample of FIG. 1 could not assign the small N peak to any particular chemical species and gave a poor-quality signal due to the low quantity of N present.

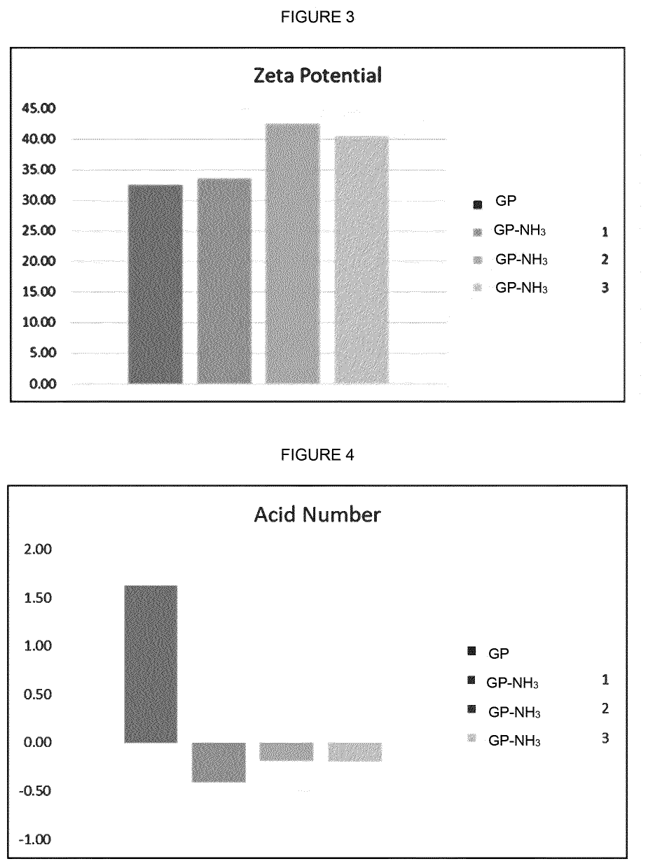

FIGS. 3 and 4 confirm that the plasma treatment of graphene particles (GP) with ammonia (GP-NH₃) was successful in providing nitrogen functionalisation. These figures show the zeta potential increased after treatment (FIG. 3), and the acid number went negative after treatment (FIG. 4). Note that the references 1, 2 and 3 refer to different batches of ammonia treated (nitrogen functionalised) graphene particles.

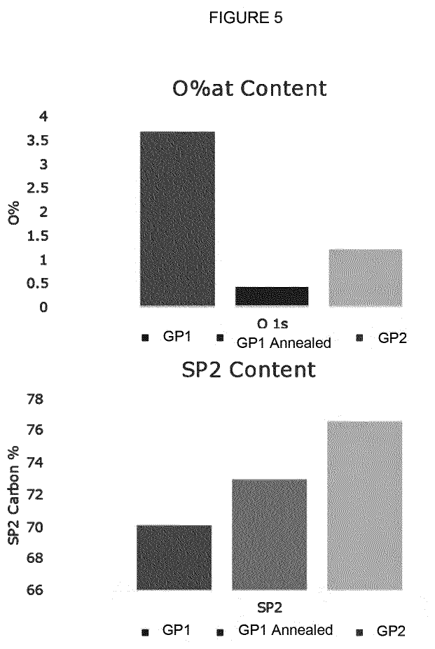

FIG. 5 shows the effect of annealing on graphene particles. In the upper graph, the change in O at % is monitored. The left bar shows unannealed graphene particles (GP1) having 3.7 O at %. The middle bar shows annealing treatment at 800° C. reduced the amount of oxygen to less than 0.5 at %. The rightmost bar shows untreated sample of graphene particles having an intrinsically low oxygen content, of less than 1.5 at %.

As can be seen in the lowermost graph, the annealing treatment only slightly impacted the sp² content. In particular, the annealing treatment increased the sp² carbon content by around 3%. The graphene particles having intrinsically low oxygen content had higher sp² carbon content, around 77%.

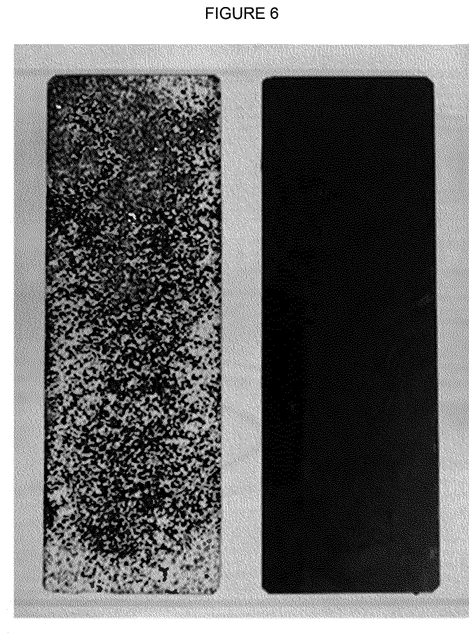

FIG. 6 shows that graphene particles with functionalisation as described herein (i.e. having less than 4 at % oxygen and more than 3 at % nitrogen) show good dispersibility in a polymer matrix material.

In particular, the sample containing graphene particles according to the invention (right) are consistently black across the sample, while the sample containing graphene particles not functionalised according to the invention (left) shows reduced dispersibility. In particular, the reduced dispersibility can be observed by inconsistent coloration across the sample, indicating the presence of clumps or areas of higher and areas of lower graphene particle concentrations. In contrast, no such clumping can be seen in the sample on the right, indicative of consistent graphene particle dispersion. The left and right samples contain the same (around 1% by mass) loading of graphene particles.

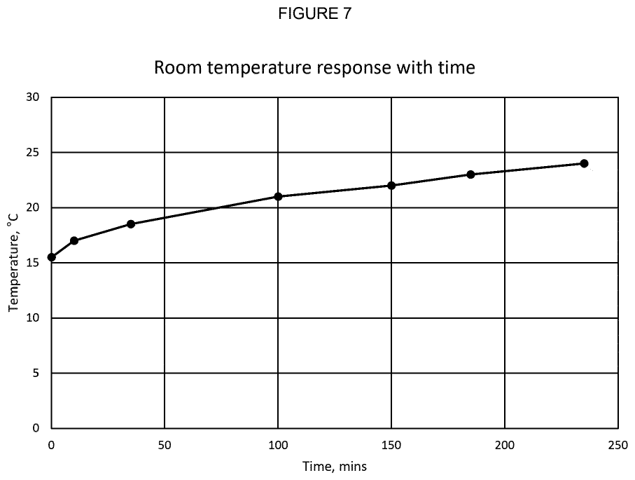

FIG. 7 shows the temperature of an enclosed room of 12.72 m² area with a maintained starting temperature of 15.5° C. as it is heated by four large area heating panels over 4 hours. The temperature reached 20° C. within an hour of operation and reached just under 25° C. in the specified time.

### EXAMPLES

### Experiment 1

In a first set of experiments, the dispersibility of graphene particles as used in the present invention was assessed.

Graphene particles according to the claims were combined with a polymer matrix material and stirred manually.

Visually, it was observed that the polymer matrix material became consistently blackened following stirring. See e.g. FIG. 6.

The results supported that the graphene particles according to the claims dispersed well in a polymer matrix material.

### Experiment 2

In a second set of experiments, the effect of low oxygen content and nitrogen functionalisation of the graphene particles on resistivity was assessed.

Two inks containing graphene particles were prepared. A first ink was nitrogen functionalised using ammonia plasma treatment, but also had high oxygen content (more than 4 at %). A second ink was prepared having both low oxygen content and was plasma treated to incorporate nitrogen functionalisation, as described herein.

In the following, the polymer matrix material and other components were kept constant. The mass content of graphene particles in each ink was adjusted slightly to achieve inks having comparable viscosity. The difference in mass content is not expected to have a significant effect on resistivity.

| | Graphene particle | Viscosity | Resistivity |
|---|---|---|---|
| Ink | functionalisation | (Pa · s) | (Ω) |
| Comparative | High oxygen, with | 14.87 | 314 |
| Example 1 | nitrogen | | |
| | functionalisation | | |
| Example 1 | Low oxygen, with | 15.13 | 17.06 |
| | nitrogen | | |
| | functionalisation | | |

For direct comparison, the inks of Comparative Example 1 and Example 1 were screen printed and a normalised resistivity calculated. The results were as follows:

| Ink | Normalised Resistivity (50 micron Ω) |
|---|---|
| Comparative Example 1 | 57 |
| Example 1 | 14.7 |

It can be seen that optimal resistivity is achieved by using graphene particles having both low oxygen content and nitrogen functionalisation.

### Experiment 3

In a third set of experiments, the heating abilities of four large area heating panels were assessed.

Four large area (1000×600 mm) heating panels were manufactured. All heating panels were connected to an off the shelf power supply box capable of supplying 230 V AC. The temperature was recorded using a thermocouple. The panels were tested together in an enclosed room with 12.72 m² area maintained at 15.5° C. room temperature with the aim to raise the room temperature to 25° C. within a 4-hour time period.

FIG. 7 shows the room temperature response to heating of the four heating panels over time. The average current consumption by all four panels was approximately 3.97 A. It can be seen from FIG. 7 that the heating panels reached almost 25° C. over 4 hours consuming just 2.18 kWh of energy on average, which is significantly lower than what conventional heating systems normally consume. It is noteworthy in this case that the room temperature reached 20° C. within an hour of operation. This is comparable to traditional heating methods (e.g., heat-pumps, gas radiators and cable underfloor heaters) used to keep a household warm by maintaining an average temperature of 20° C. during cold weather conditions—a 1500 W gas radiator would achieve a similar effect but has almost three times the power rating and it would cost more money to run and maintain in the long term. This is due to the functionalised graphene containing conductive layer of the heating panels being highly responsive to the applied voltage and current due to its exceptional electrical and thermal properties.

| Average | Average | Average Power | Average Consumption |
|---|---|---|---|
| Voltage (V) | Current (A) | (W) | (kWh) |
| 233.6 | 3.97 | 544.1 | 2.18 |

### Experiment 4

In a fourth experiment, the heat distribution of the heating panel was assessed. A heating panel was heated to approximately 37° C. and a thermal imaging camera was used to view the heat distribution across the panel. The image showed very minimal variation across the panel confirming that the panels provide uniform heating and avoid the formation of hotspots.

In general, it is favourable to improve power consumption and heat-up times for commercial applications. This means that smaller power supplies can be used with increased time between charges or generally less power consumption. The inventor has found that certain inks prepared according to the present invention can achieve an increase in temperature from ambient temperature to 60° C. in just 30 s at an applied voltage under 24V. Of course, different heating rates can be recorded at different applied voltages. Accordingly, heating panels of the invention show properties well-suited for commercial applications.

In respect of numerical ranges disclosed in the present description it will of course be understood that in the normal way the technical criterion for the upper limit is different from the technical criterion for the lower limit, i.e. the upper and lower limits are intrinsically distinct proposals.

For the avoidance of doubt it is confirmed that in the general description above, in the usual way the proposal of general preferences and options in respect of different features of the heating panel, heating system, and heated flooring element and methods described above constitutes the proposal of general combinations of those general preferences and options for the different features, insofar as they are combinable and compatible and are put forward in the same context.

1. A heating panel for use in underfloor heating comprising a conductive layer of graphene particles dispersed in a polymer matrix material, wherein the graphene particles have an oxygen content of less than 4 at % and a nitrogen content of at least 3 at %, wherein the oxygen and nitrogen contents may be measured by XPS.

2. The heating panel according to claim 1, wherein the oxygen content is less than 2 at % or less than 1.5 at %.

3. The heating panel according to claim 1, wherein the oxygen content is less than 1 at %.

4. The heating panel according to claim 1, wherein the oxygen content is less than 0.5 at %.

5. The heating panel according to claim 1, wherein the graphene particles have a nitrogen content of at least 5 at %.

6. The heating panel according to claim 1, wherein the graphene particles have a nitrogen content of no more than 21 at %.

7. The heating panel according to claim 1, wherein the graphene particles have a nitrogen content of between 10 at % and 20 at %.

8. (canceled)

9. The heating panel according to claim 1, wherein the graphene particles have at least one of a zeta potential at pH3 in a range of at least 3 mV and an acid number of less than zero.

10. The heating panel according to claim 1, wherein the graphene particles are graphene nanoplatelets, and wherein the graphene particles may have an average of 2 to 5 graphene layers per particle.

11. The heating panel according to claim 1, wherein the polymer matrix material is an elastic material.

12. The heating panel according to claim 1, comprising multiple stacked layers of conductive material.

13. The heating panel according to claim 12, comprising one or more protective layers encapsulating one or more of the conductive layers, wherein the one or more protective layers are electrically insulating.

14. The heating panel according to claim 13, wherein the one of more protective layers comprise a material which is the same as the polymer matrix material.

15. The heating panel according to claim 12, wherein a average thickness of one or more of the conductive layers is 300 μm or less.

16. The heating panel according to claim 1, wherein an average thickness of the heating panel is 5 mm or less, and wherein the heating panel may comprise an electrical connector, preferably at the corner.

17. (canceled)

18. A heating system for underfloor heating, comprising one or more heating panels according to claim 1, wherein the one or more heating panels may be electrically connected.

19. (canceled)

20. The heating system according to claim 18, wherein the heating system comprises two or more heating panels, and wherein the temperature control system is configured to allow independent control over some or each of the two or more heating panels.

21. A method of making a heating panel according to claim 1, comprising:
providing an electrically insulating substrate material;
depositing one or more layers of a conductive material onto at least a portion of the substrate material; and
depositing an electrically insulating covering layer onto said one or more layers of conductive material;
wherein the conductive material comprises graphene particles dispersed in a polymer matrix material, and wherein the graphene particles have an oxygen content of less than 4 at % and a nitrogen content of at least 3 at %.

22. The method of making a heating panel according to claim 21, wherein the conductive material is prepared using a method comprising:
providing a starting carbon material, comprising graphitic particles;
optionally annealing the starting material to remove oxygen;
subjecting the annealed material to plasma treatment and agitation in a treatment chamber;
chemically functionalising the carbon material by components of a plasma-forming gas, which is preferably ammonia; and
dispersing the functionalised material in a polymer matrix material.

23. (canceled)

24. (canceled)

25. (canceled)
